(19) United States
(12) Patent Application Publication
(10) Pub. No.: US 2007/0054529 A1
(43) Pub. Date: Mar. 8, 2007

(54) Connector with improved operating portion

(75) Inventors: Tod M. Harlan, Mechanicsburg, PA (US); Kevin E. Walker, Hershey, PA (US); Robert W. Brown, Harrisburg, PA (US); Joanne E. Shipe, Harrisburg, PA (US); Brian J. Gillespie, Harrisburg, PA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/480,131

(22) Filed: Jun. 29, 2006

Related U.S. Application Data
(63) Continuation-in-part of application No. 11/218,955, filed on Sep. 3, 2005.

(51) Int. Cl. H01R 13/15

(52) U.S. Cl. 439/260

(57) ABSTRACT

An electrical connector for connecting a sheet-like connection member comprises a housing (1) defining an insertion slot (10), a number of contacts (2) arranged in the housing, each contact having a contact beam (22) exposed in the insertion slot and a bearing beam (21) extending substantially parallel to the contact beam, and a pressing member (3) associated with the housing and pivotally moveable relative to the housing. The pressing member is provided with an urging portion so as to have the connection member and the corresponding contacts engage with each other. The pressing member further defines an operating portion (36) opposite to the urging portion and extending outwardly away from a pivot axis (P) of the pressing member than other portions of the pressing member so as to allow operators to press in the center of the pressing member where the operating portion is situated. The operating portion also provides an available surface for picking and placing operation.

### CROSS-REFERENCE OF RELATED APPLICATION

The instant application is a C-I-P of the pending U.S. Patent Application entitled “CONNECTOR WITH IMPROVED PULLING PORTION” filed on Sep. 3, 2005, Ser. No. 11/218,955, which is invented by the same inventors as this patent application and assigned to the same assignee with this application.

### BACKGROUND OF THE INVENTION

1. Field of the Invention

The present invention relates to an electrical connector, and more particularly to an electrical connector for a sheet-like connection member such as a flexible printed circuit or a flexible flat cable.

2. Description of Related Art

U.S. Pat. No. 6,099,346 discloses a conventional connector adapted for connecting a flexible printed circuit (FPC). The FPC connector includes a housing having an open mouth, a plurality of contacts arranged and secured in the housing, each contact having a contact beam exposed to the open mouth for contacting the FPC and a pivot beam corresponding to and opposed to the contact beam, and a pressing member rotatable between an open position where said FPC can be inserted into said open mouth and a closed position where said FPC is pressed to electrically engage with said contacts. Each pivot beam of said contact is formed with a hook-like end providing a pivot cavity, and the pressing member defines a plurality of grooves for receiving said hook-like ends. Similar FPC connector can also be found in U.S. Pat. No. 6,893,288.

However, as these FPC connectors are built to lower profile heights, the pressing member may lose a significant mount of rigidity. There is, therefore, a risk that if a user presses on end of the pressing member to close it, that end or side of the pressing member may lock but the other end or side might remain open or unlocked. Furthermore, the FPC connectors are generally placed at a printed circuit board by a vacuum apparatus in view of production efficiency or other related factors. Previously, the suction nozzle of the vacuum apparatus is placed or operates on the connector housings, but these FPC connectors are often designed not only low profile but also miniature profile for saving space of electronic devices, resulting in the housings having too small surface to pick and place by the suction nozzle. In addition, in some situations such as repair and replacement of electrical system, the pressing member is required to be shifted to the open position for releasing the FPC safely. Because of small size of these FPC connectors, users may fail to open the pressing members completely, thus inadvertently forcing the FPC out of the connector mouth. With the continued tendency of miniaturization, it can be understood that the operation of opening and closing the pressing member properly will become more and more important.

Therefore, a new connector is desired to overcome the disadvantages of the prior art connectors

### SUMMARY OF THE INVENTION

An object of the present invention is to provide an electrical connector with a pressing member which can be conveniently operated.

Another object of the present invention is to provide an electrical connector with a pressing member which can provide a sufficiently large surface for picking and placing by a vacuum apparatus.

In order to achieve above-mentioned objects, an electrical connector for a flexible printed circuit (FPC) in accordance with the present invention comprises a housing defining an insertion slot along a longitudinal direction of the housing; a plurality of contacts arranged in the housing and extending along a front-to-back direction perpendicular to said longitudinal direction, each contact having a contact beam exposed in the insertion slot for contacting said FPC and a bearing beam extending substantially parallel to the contact beam; and a pressing member comprising an urging portion exerting force on the FPC to engage with said contacts and an operating portion opposite to the urging portion and extending farther away from a central portion of a pivot axis of the pressing member than other portions of the pressing member so as to form a projection for encouraging operators to press approximately a center of the pressing member. Additionally, the pressing member with the extended operating portion provides an available surface for picking and placing by a vacuum apparatus to a selected position on a printed circuit board, and the moment created by gravity of the housing and contacts combination causes the pressing member to remain closed during that process. According to the second object of the present invention, the operating portion can also extends most or even the entire length of the pressing member.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled perspective view of an electrical connector in accordance with the present invention;

FIG. 2 is an exploded perspective view of the electrical connector shown in FIG. 1;

FIG. 3 is a cross-sectional view of FIG. 1 taken along line 3-3, schematically showing the electrical connector is picked by a suction nozzle of a vacuum apparatus;

FIG. 4 is a cross-sectional view of FIG. 1 taken along line 3-3, wherein a pressing member is at a closed position with a flexible printed circuit inserted; and

FIG. 5 is a partly enlarged view of the FPC connector shown in FIG. 1, especially showing installation of contacts in a housing thereof.

### DETAILED DESCRIPTION OF THE INVENTION

Reference will now be made to the drawing figures to describe the preferred embodiment of the present invention in detail.

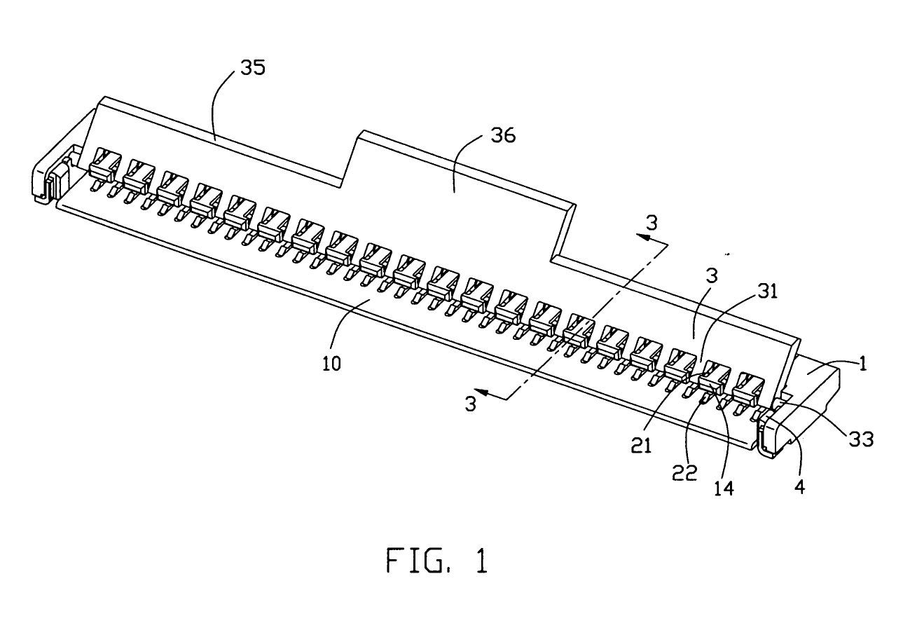

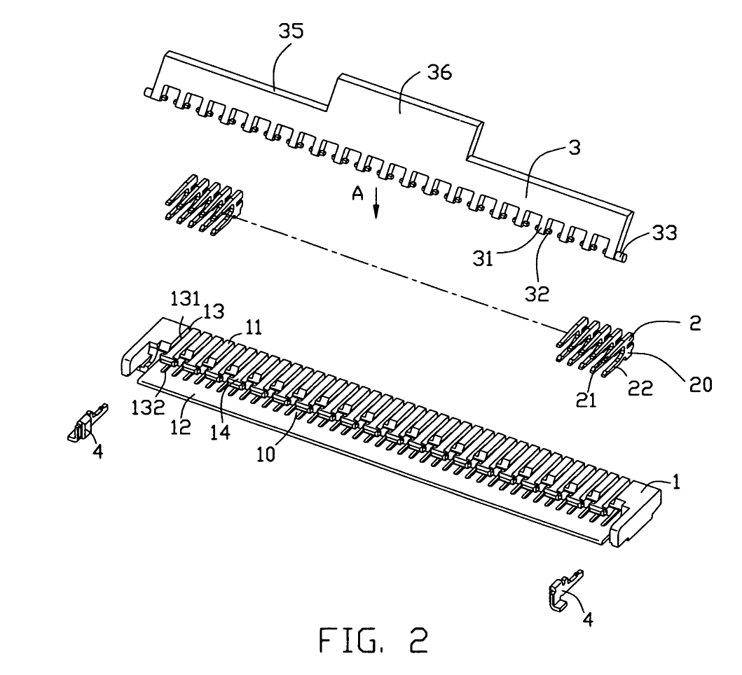

Referring to FIGS. 1 and 2, an electrical connector for connecting a flexible printed circuit (FPC) 5 with a printed circuit board (PCB) in accordance with the present invention is provided. The FPC connector comprises an insulative housing 1, a plurality of contacts 2, a pressing member 3, and a pair of support members 4. The FPC connector is provided with an FPC insertion slot 10 extending along a longitudinal direction of housing 1 at the front portion thereof. A lower portion of the FPC insertion slot 10 is provided by a bottom wall 12 of the housing 1, and an upper portion of the FPC insertion slot 10 is designed to be opened and closed by the pressing member 3.

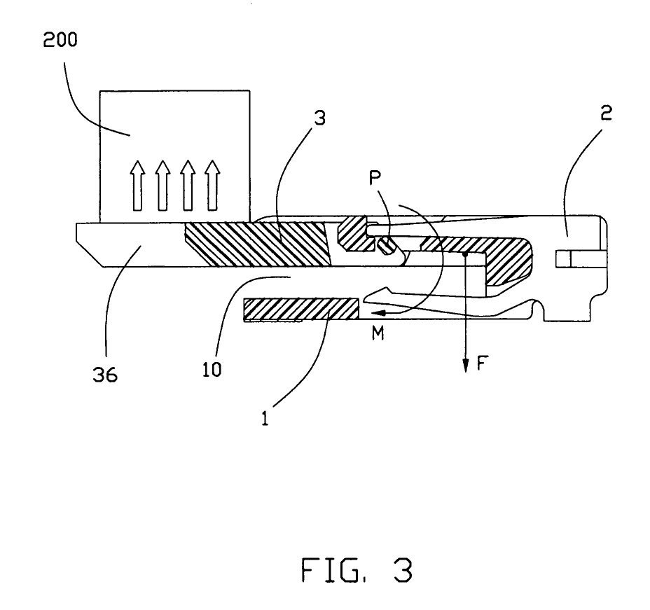

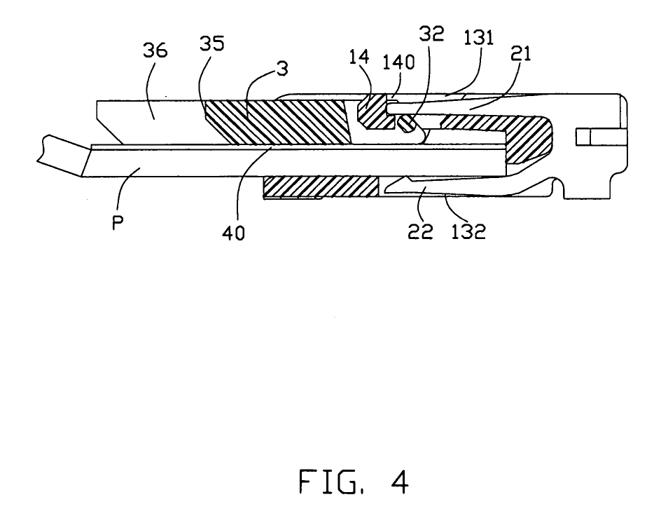

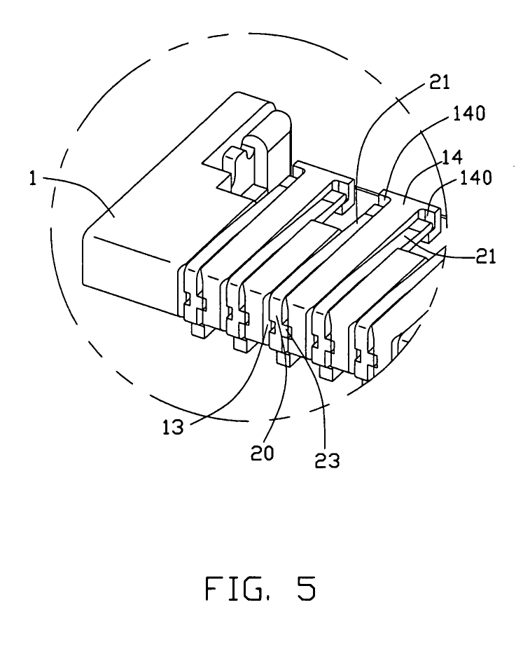

The housing 1 is provided with a plurality of contact receiving grooves 13 extending along a front-to-back direction perpendicular to said longitudinal direction, each of which comprises an upper groove 131 and a lower groove 132 exposing to a rear portion thereof for accommodating the contact 2, as shown in FIGS. 3 and 4. The contacts 2 are respectively accommodated in the contact receiving grooves 13 and therefore are arranged in side-by-side relationship with a predetermined pitch at the rear portion of the housing 1. Each contact 2 has a bearing beam 21 and a contact beam 22 extending parallel from a base portion 20 in cantilevered fashion. As best shown in FIG. 5, the bearing beam 21 extends along an upper wall 11 of the housing 1 and is upwardly exposed to exterior as the groove defined in the upper wall 11 for accommodating the bearing beam 21 is upwardly opened. The contact beam 22 extends along the bottom wall 12 of the housing 1, near the lower portion of the FPC inserting portion 10, and is downwardly exposed to exterior as the groove defined in the bottom wall 12 for accommodating the contact beam 22 is downwardly opened. Such a structural design minimizes height of the upper wall 11 and the bottom wall 12 of the housing 1 and thus would reduce the whole height of the FPC connector, thereby forming a lower profile FPC connector. Each contact 2 further comprises a retaining tuber 23 protruding sideward from the base portion 20 and adapted to be set in the housing 1. The installed contacts 2 are thereby fixed in the housing 1 by engagement between the retaining tuber 23 and the housing 1.

The housing 1 is provided with a plurality of T-shaped lips 14 (as viewed from a top of the housing) each of which integrally extends forward from the upper wall 11 of the housing 1 and defines a pair of inwardly opened recesses 140 in its enlarged head portion for respectively receiving a tip of the bearing beam 21.

The pressing member 3 is formed into a planar shape so as to open and close the upper portion of the FPC insertion slot 10. In order to engage with the housing 1 and the contacts 2, the pressing member 3 has a comb-like urging portion located at a rear portion thereof which is formed with a plurality of wedge portions 31 functioning as a cam portion interposed between the bearing beams 21 without the T-shaped lips 14 therebetween, i.e., each cam portion is situated between two adjacent bearing beams 21 that are themselves between two T-shaped lips 14. The pressing member 3 is also provided with a pair of shaft sects 32 respectively extending from two sides of each wedge portion 31, a pair of bosses 33 on both ends of the urging portion adapted to be held on the support members 4 installed in both side portions of the housing 1, and an extended tab 36 opposite to the urging portion and extending away from a middle portion of a front face 35 of the pressing member 3. The bosses 33 may not be required for the pressing member 3 to be functional between the FPC 5 and the housing and contacts combination.

Referring again to FIGS. 1, 2 and 4, assembling of the pressing member 3 is performed by placing the shaft sects 32 below corresponding bearing beams 21 and behind the enlarged heads of corresponding T-shaped lips 14. Then the support members 4 are respectively retained to the side portions of the housing 1 to support the bosses 33 of the pressing member 3 from downward movement and therefore to maintain the shaft sect 32 immediately below or in engagement with the bearing beam 21. As mentioned above, since the cam portions 31 are interposed between bearing beams 21 without T-shaped lips therebetween, the shaft sects 32 are respectively supported below the bearing beams 21 from upward movement and supported behind the enlarged head portions that form the bottom portions of the recesses 140 from forward movement. The pressing member 3 is pivotally moveable about a pivot axis P relative to the housing from an open position as shown in FIG. 1 to the closed position as shown in FIG. 4. As the extended tab 36 extends farther away from the pivot axis P of the pressing member 3 than other portions of the pressing member 3 so as to form a projection, after the FPC 5 is inserted into the FPC insertion slot 10, the extended tab 36 serving as an operating portion allows or encourages operators to press in the center of the pressing member 3 to rotate it to said closed position, thereby insuring that the cam portions 31 along the entire length of the pressing member 3 close completely, while the extended tab 36 does not substantially increase the profile of the FPC connector. As shown in FIG. 4, the FPC 5 may be formed with an end stiffener 40 extending over the bottom of the space mostly occupied by the extended tab 36. The end stiffener 40 not only can protect the pressing member 3 from crushing the FPC 5 but also can prevent a lifting motion of the FPC 5 from opening the pressing member inadvertently due to presence of the extended tab 36.

Referring to FIG. 3, before inserting the FPC 5 into the FPC insertion slot 10, the FPC connector should be picked and placed by a vacuum apparatus (not shown) to a predetermined position on a printed circuit board (not shown). The pressing member 3 with the extended tab 36 can be used to provide a unique and previously unavailable surface for a suction nozzle 200 of the vacuum apparatus, and the nature of FPC connector is such that the pressing member 3 will remain closed during the entire transferring or placing process because of the moment M created by center of gravity F of the housing 1 and contacts 2. For providing a larger surface for picking and placing by the suction nozzle, the entire length of the pressing member 3 also can be extended rather that just a tab like the extended tab 36 to function as the operating portion.

Once the FPC connector is removed by reason of repair or displacement from a printed circuit board to which it is mounted, operators can pull said operating portion to drive the pressing member 3 from the closed position to the open position so as to remove the FPC 5 without any risk of scraping the FPC. The operating portion extends forward farther than other conventional FPC connectors from the pivot axis P of the pressing member 3 so that the operating portion is conveniently operated. Even if the size of the FPC connector becomes smaller, the desired operation of the pressing member 3 is still achieved as long as the pulling force is exerted on operating portion.

It is noted that the pressing member 3 with the operating portion is suitably used on any electrical connector for connecting a sheet-like connecting member but not limited to the FPC connector disclosed above.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector adapted for connecting with a flexible printed circuit (FPC), comprising:
an insulative housing defining an FPC insertion slot extending along a longitudinal direction of the housing;
a plurality of contacts disposed in the housing and extending along a front-to-back direction perpendicular to said longitudinal direction; and
a pressing member associated with the housing and moveable relative to the housing about a pivot axis thereof, said pressing member providing an urging portion for having the FPC and the corresponding contacts engage with each other, the pressing member having an operating portion opposite to said urging portion and extending forwardly away from the pivot axis of the pressing member for providing an available surface for picking and placing by a vacuum apparatus.

2. The electrical connector as claimed in claim 1, wherein said operating portion extends farther than other portions of the pressing member so as to form a projection of the pressing member.

3. The electrical connector as claimed in claim 1, wherein said operating portion extends an entire length of the pressing member along the longitudinal direction of the housing.

4. The electrical connector as claimed in claim 1, wherein the operating portion and the center of gravity of the housing and contacts are located at opposite sides of the pivot axis of the pressing member.

5. The electrical connector as claimed in claim 1, further comprising a pair of support members, and wherein the pressing member comprises a pair of end bosses supported by the support members.

6. An electrical connector adapted for connecting with a flexible printed circuit (FPC), comprising:
an insulative housing defining an FPC insertion slot extending along a longitudinal direction of the housing;
a plurality of contacts disposed in the housing and extending along a front-to-back direction perpendicular to said longitudinal direction; and
a pressing member associated with and moveable relative to the housing, said pressing member defining a comb-like structure on a rear portion for providing an urging portion for having the FPC and the corresponding contacts engage with each other, and a plate on a front portion for providing not only a holding section to positioning the FPC but also an operating portion for actuating the pressing member relative to the housing; wherein
said plate defines a widest region along said front-to-back direction, and said widest region extending forwardly beyond a front edge of said housing with a distance not less than one half of a width of said housing along said front-to-back direction so as to provide a sufficient upward planar surface for picking and placing by a vacuum apparatus, when the pressing member is located in a fixed position.

7. The electrical connector as claimed in claim 6, wherein said widest region is located on a middle section of said pressing member along the longitudinal direction.

8. The electrical connector as claimed in claim 7, wherein said widest region has two times width along said front-to-back direction, compared with other remaining portions of the pressing member.

9. The electrical connector as claimed in claim 8, wherein front edges of both said widest region and the other remaining portions extend beyond the front edge of the housing, when said pressing member is located at the fixed position.

10. The electrical connector as claimed in claim 9, wherein one half of the pressing member is located on the housing and the other half suspends beyond the front edge of the housing, when said pressing member is located at the fixed position.

11. The electrical connector as claimed in claim 6, wherein said pressing member is rotatable relative to the housing.

12. An electrical connector adapted for connecting with a flexible printed circuit (FPC), comprising:
an insulative housing defining an FPC insertion slot extending along a longitudinal direction of the housing;
a plurality of contacts disposed in the housing and extending along a front-to-back direction perpendicular to said longitudinal direction; and
a pressing member associated with and moveable relative to the housing, said pressing member defining a comb-like structure on a rear portion for providing an urging portion to have the FPC and the corresponding contacts engage with each other, and a plate on a front portion for providing not only a holding section to position the FPC in position but also an operating portion for actuating the pressing member relative to the housing; wherein
said plate is widened on a middle portion thereof by increasing a width along the front-to-back direction with a distance which may compensate a width of said comb-like structure so as to provide a sufficient suction area on an upward surface of the pressing member for vacuum use.
